(19) United States
(12) Patent Application Publication
(10) Pub. No.: US 2002/0154754 A1
(43) Pub. Date: Oct. 24, 2002

(54) Call screener

(76) Inventor: Ralph Karsten, Saint Paul, MN (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 09/837,780

(22) Filed: Apr. 18, 2001

(51) Int. Cl. H04M 3/42

(52) U.S. Cl. 379/210.02; 379/207.13

(57) ABSTRACT

The present invention is a method and apparatus for processing incoming calls in a communication system. The system intercepts incoming calls preventing communication with a target device for which the incoming call is intended. The system prompts the initiator of the incoming call to input a unique access code. Upon receiving the unique access code from the initiator of the incoming call, the system passes the incoming call to the target device. When the unique access code is not provided by the initiator of the incoming call, the system prevents the incoming call from reaching the target device.

### CROSS-REFERENCE TO RELATED APPLICATION(S)

None.

### BACKGROUND OF THE INVENTION

The present invention relates to a communication access system. More specifically, the present invention relates to a method and apparatus used to control access to a target device such as a telephone, fax machine, voice mail, computer or other related communication devices.

A frequent problem encountered in the modem world by almost anyone in an industrialized society is the invasion of privacy and interference in daily lives and business operations by unwanted calls on telephones, fax machines, voice mail, computer and other related communication devices. Increasingly, these unsolicited nuisance calls invade homes and businesses during business hours and even into evening hours.

The current technology aimed at screening out these nuisance calls include the use of caller identification or “caller-ID”. Caller-ID is a service offered through the telephone company that allows a telephone user to determine who is calling without first actually answering the telephone call. Although this system can be useful in screening calls, it does not prevent the calls from coming through to the user's telephone.

Another type of technology used for screening are phone number blocking systems offered by the telephone companies. These services by the telephone company do allow some phone calls to be blocked from reaching a home. This technology falls well short, however, of blocking all unwanted calls. And, it is quite expensive over a period of time. An invention that overcomes the limitations of the prior art would be very useful.

### BRIEF SUMMARY OF THE INVENTION

The present invention is a call screener method and apparatus for screening unwanted calls. The call screener receives incoming calls and prompts the incoming call for a unique access code. When the correct unique access code is entered, the incoming call is connected with a target device. When an incorrect or no unique access code is provided, the incoming call is either terminated or routed to a message storage system without connection with the target device.

### BRIEF DESCRIPTION OF THE DRAWINGS

FIG. 1 is a block diagram of a basic access code system in accordance with the present invention.

FIG. 2 is a more detailed block diagram of one embodiment of an access code system.

FIG. 3 is a more detailed block diagram of another embodiment of an access code system.

### DETAILED DESCRIPTION

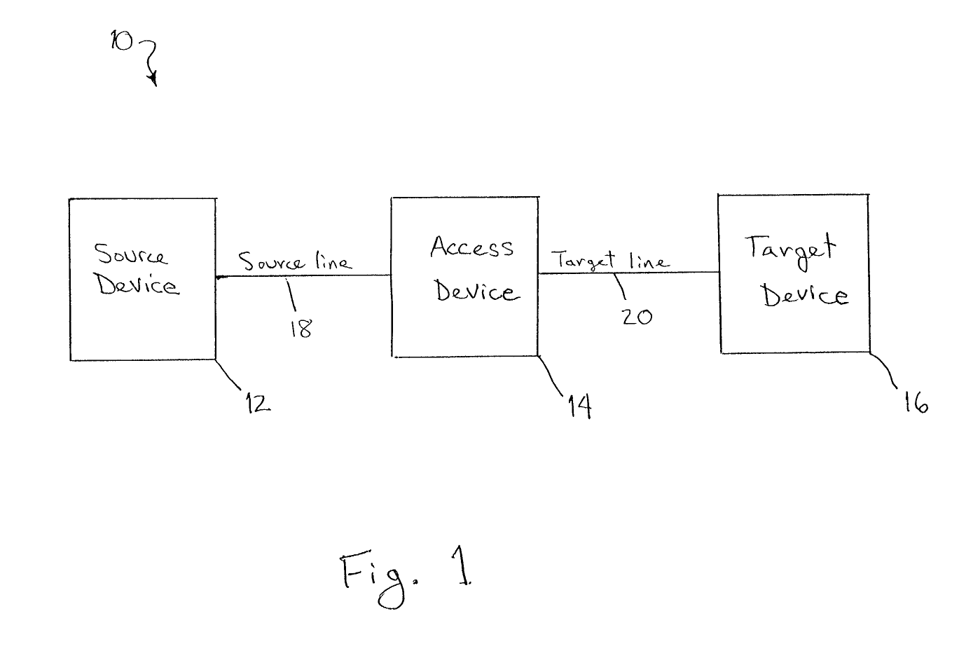

FIG. 1 shows access code system 10 in accordance with the present invention. Access code system 10 includes source device 12, access device 14, and target device 16. Source device 12 is coupled to access device 14 by source line 18. Access device 14 is connected to target device 16 by target line 20.

In operation, access code system 10 can be used to control access to target device 16 by source device 12. Both source device 12 and target device 16 may be a variety of electronic communication devices such as telephones, fax machines, answering machines, voice mail systems, computers or related communication devices. In operation, source device 12 initiates communication intended for target device 16 by sending communication signals over source line 18. Access device 14 intercepts the communication from source device 12 preventing communication with target device 16. Access device 14 then prompts source device 12 for a unique access code. If access device 14 receives the unique access code from source device 12, then access device 14 connects source device 12 with target device 16 over target line 20. If access device 14 does not receive the unique access code from source device 12, then the communication from source device 12 may be terminated. In this way, someone seeking to place a communication with target device 16 can only do so with knowledge of a unique access code that is given in response to prompting by access device 14. Access device 14 effectively prevents all communication with target device 16 without use of the unique access code.

By way of example, source device 12 and target device 16 are telephones. Access device 14 and target device 12 are typically located in the same place, such as within a home or a business. Source device 12 is a telephone located at a distant location from the home or business in which access device 14 and target device 16 are located. Source device 12 is connected with access device 14 over source line 18 which is typically a telephone transmission line. When a phone call initiator uses source device 12 to initiate a phone call intended for target device 16, that phone call is intercepted by access device 14 in the home or business. Access device 14 then prompts the phone call initiator to input a unique access code. If the phone call initiator fails to input any code, or inputs a code other than the unique access code, the phone call is terminated. If the phone call initiator inputs the unique access code in response to prompting from access device 14, then access device 14 passes the phone call to the target device 16 over target line 20. In this way, a person located in the home or business only receives notification of a phone call after the initiator of that phone call inputs the unique access code. If the initiator of the phone call fails to input the unique access code, then the call is never passed on to target device 16 so that target device 16 never rings and the person in the home or business is not immediately aware that a phone call was made.

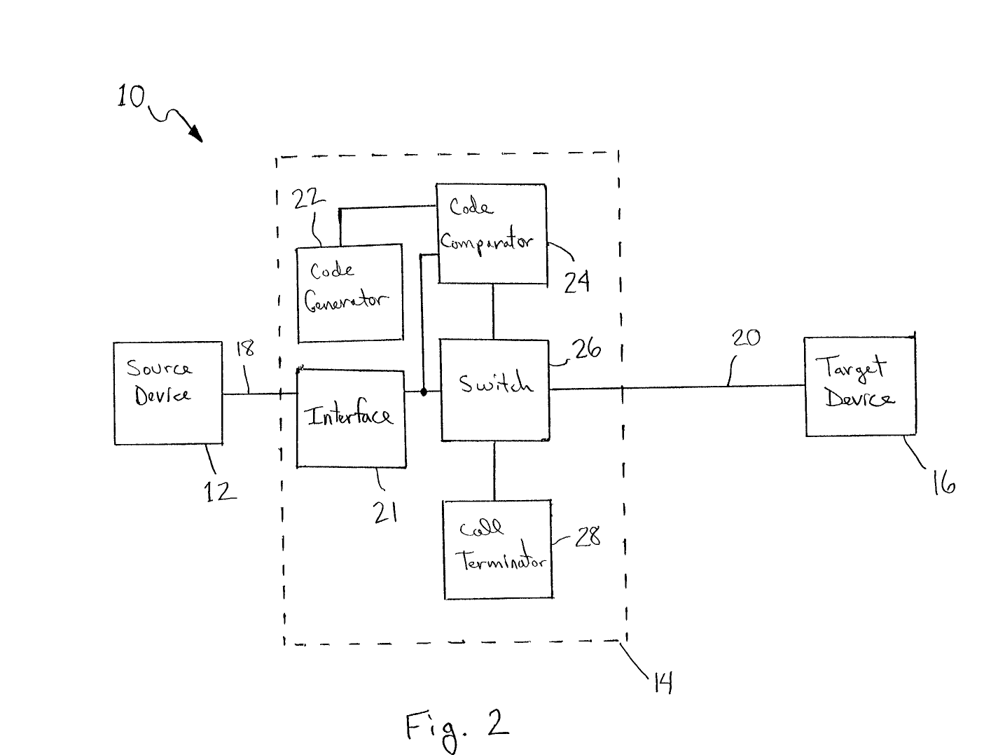

FIG. 2 shows a more detailed diagram of access code system 10 in accordance with the present invention. Access code system 10 includes source device 12, access device 14, and target device 16. Access device 14 includes interface 21, code generator 22, code comparator 24, switch 26 and call terminator 28. Source device 12 and target device 16 are coupled to access device 14 as described above with respect to FIG. 1. Within access device 14, interface 21, code generator 22, code comparator 24, switch 26 and call terminator 28 cooperate to control access by source device 12 to target device 16.

In operation, source device 12 is prompted for an access code by interface 21. Interface 21 then receives any responsive signals from source devece 12. Code generator 22 generates a unique code. This unique code could be randomly generated or selected by a user of access code system 10. It also could be changeable at the discretion of the user. The code generated by code generator 22 is sent to code comparator 24. Code comparator 24 also receives the signals from source device 12. If code comparator determines that the unique code received from code generator 22 matches the signals transmitted from source device 12 in response to prompting from interface 21, then code comparator 24 controls switch 26 to allow source device 12 to be coupled to target device 16 over target line 20. If code comparator 24 determines that the unique code generated by code generator 22 does not match the signals from source device 12, or that source device 12 did not generate signals, then code comparator 24 controls switch 26 such that source device 12 is coupled to call terminator 28. In this way, when the source device 12 does not input the correct unique access code, communication from source device 12 is terminated without ever connecting to target device 16.

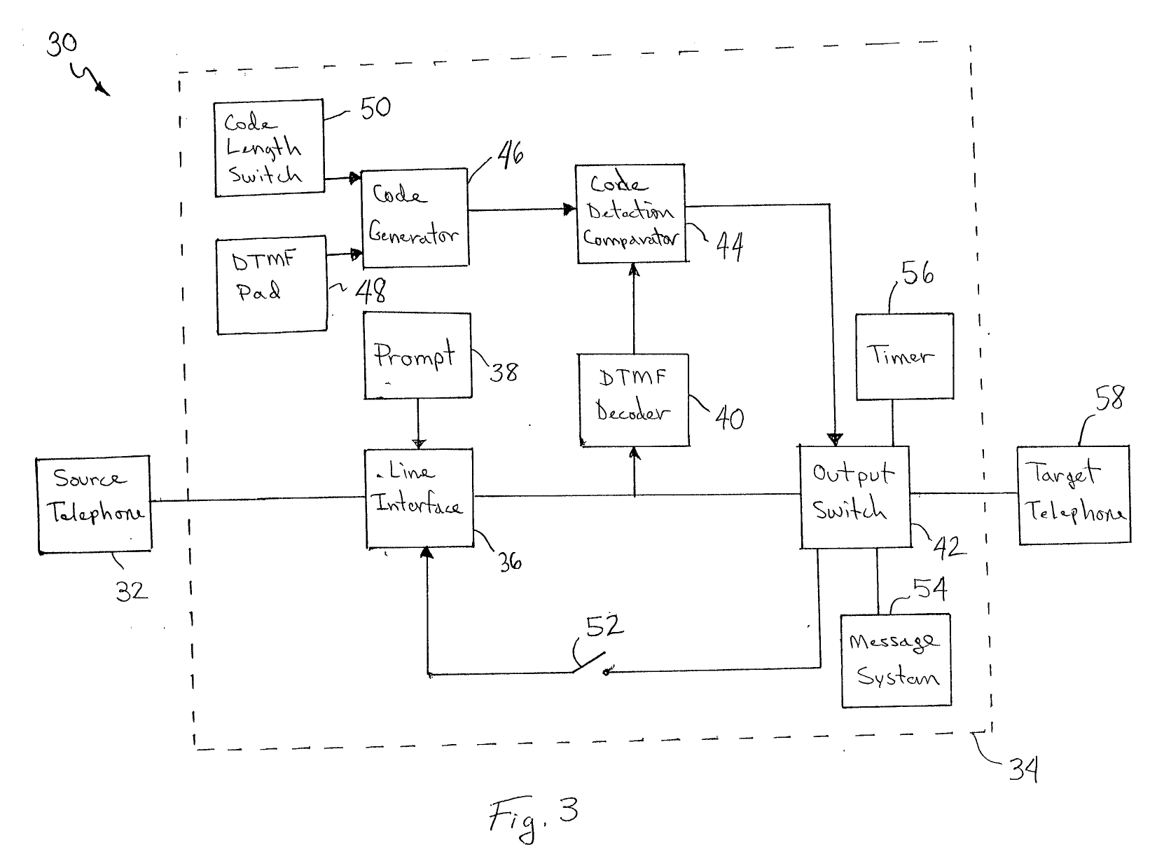

FIG. 3 shows a more detailed implementation of access code system 30 in accordance with the present invention. Access code system 30 includes source telephone 32, access device 34, including line interface 36, prompt 38, DTMF decoder 40, output switch 42, code detection comparator 44, code generator 46, DTMF pad 48, code length switch 50, hangup switch 52, message system 54, and timer 56, and target telephone 58.

Source telephone 32 is coupled to line interface 36 of access device 34 such that signals can be sent back and forth between telephone 32 and line interface 36. Line interface 36 is coupled with prompt 38 and can receive signals therefrom. Line interface 36 is coupled with, and can transmit signals to, DTMF decoder 40 and output switch 42. DTMF decoder 40 is coupled with, and can transmit signals to, code detection comparator 44. Code detection comparator 44 is coupled with code generator 46 and can receive signals therefrom. Code generator 46 is coupled with DTMF pad 48 and code length switch 50 and can receive signals from both. Code detection comparator 44 is coupled with output switch 42 and can send signals thereto. Output switch 42 is coupled with hangup switch 52 and message system 54 and can send signals to both. Hangup switch 52 is coupled back to line interface 36. Timer 56 is coupled with output switch 42 and can send signals thereto. Target telephone 58 is coupled to output switch 42 and can receive signals therefrom.

In operation, a phone call is initiated by phone call initiator using source telephone 32. That phone call is received by line interface 36. Line interface 36 is not directly coupled to target telephone 58. In this way, a phone call received using access code system 30 is not connected directly with target telephone, and thus, target telephone 58 does not ring initially when a phone call is placed by source telephone 32.

Instead, when line interface 36 receives a phone call from source telephone 32, line interface 36 answers the call and prompts source telephone for an input of an access code. Line interface 36 may prompt source telephone 32 in a variety of ways. For example, prompt 38 may be used to generate a tone after the call is answered from source telephone 32 by line interface 36. That tone is then passed from prompt 38 via line interface 36 back to source telephone 32. When the call initiator hears the tone prompt from prompt 38, the initiator may input an access code in response. Prompt 38 could also be programed to have a prerecorded message requesting that the phone call initiator input a unique access code. Alternatively, prompt 38 maybe completely silent, such that the initiator of the call must know to input a unique access code without any prompting signal. In all cases, it is important that line interface 36 answers the call from source telephone 32 without relaying what unique access code will allow access to target telephone 58. The call initiator must have independent knowledge of the unique access code as it will not be disclosed by prompt 38.

Line interface 36 is typically an optoisolator that allows signals to be transferred between the various electronic devices couple to it, while keeping those devices electrically isolated from each other. For example, when line interface 36 includes a optoisolator, prompt 38 and source telephone 32 can transfer signals back and forth, but still remain electrically isolated from each other.

When line interface 36 answers a phone call from source telephone 32 and prompts source telephone 32 for an input, that input will typically be a dual-tone-multi-frequency (DTMF) signal, also known as a touch-tone signal. This DTMF signal is generated by simply pressing a number on a keypad of source telephone 32. When a call initiator uses source telephone 32 to generate DTMF signals, they are routed to DTMF decoder 40. Line interface 36 also routes the phone call from source telephone 32 to output switch 42. Output switch 42 eventually routes the phone call from source telephone 32 to alternative outputs based on certain conditions discussed below.

Access code system 30 includes code generator 46, which generates an access code that is unique to access code system 30. The unique access code can be preset, randomly generated, or programmed by a user. For example, DTMF pad 48 may be used by a user of access code system 30 to input a unique access code to code generator 46. Code length switch 50 is used to regulate the length of the access code. DTMF pad 48 is similar to the number keys on a telephone and generates the audible DTMF signals for code generator 46. Using DTMF pad, the unique access code can be a single DTMF signal or a series of DTMF signals. Once the unique access code is received by code generator 46 from DTMF pad 48, the unique signal is sent to code detection comparator 44.

Code detection comparator 44 compares the unique access code from code generator 46 with the signals received from source telephone 32 and decoded by DTMF decoder 40. Based on this comparison, code detection comparator 44 controls output switch 42, which routes the incoming phone call from source telephone 32 to various output options. If the signals received from source telephone 32 (as decoded by DTMF decoder 40 and received by code detection comparator 44) match the unique access code from code generator 46 also received by code detection comparator 44, then code detection comparator 44 controls output switch 42 to connect source telephone 32 with target telephone 58. Under these circumstances, target telephone 58 will then ring, providing an indication that a telephone call has been made.

If code detection comparator 44 determines that the signal received from source telephone 32 does not match the unique access code from code generator 46, then code detection comparator 44 controls output switch 42 to route the incoming phone call to either hangup switch 52 or message system 54. Access code system 30 can be programmed to hangup on incoming phone calls that do not provide the unique access code by routing these calls to hangup switch 52. Alternatively, when an incorrect access code is received, output switch 42 can route these calls to message system 54. Message system 54 has a stored message appropriate for incoming phone calls initiated by callers not having the unique access code. For example, the message could indicate that only people with knowledge of the unique access code have access to target device 58. Alternatively, the message could simply indicate that target device 58 is not available. Message system 54 could also record messages from the user of source telephone 32. In any case, when output switch 42 directs the incoming phone calls from source telephone 32 to either hangup switch 52 or message system 54, target telephone 58 does not ring. Thus, when the user of source telephone 32 does not have the unique access code, it cannot cause target telephone 58 to ring.

In addition, timer 56 is provided in connection with output switch 42. Timer 56 monitors incoming phone calls from source telephone 32. And if the incoming call from source telephone 32 does not provide a signal in response to prompt 38 in an appropriate amount of time, timer 56 will cause output switch to direct the phone call to message system 54 or hangup switch 52. In this way, the initiator of a phone call must input a signal in response to prompt 38 in a specified amount of time or the phone call will be terminated.

Access device 34 and target telephone 58 are typically located in the same place, such as within a home or a business. Source telephone 32 is located at a distant location from the home or business in which access device 34 and target telephone 58 are located. Source telephone 32 is typically connected with access device 34 over a telephone transmission line. When a phone call initiator uses source telephone 32 to initiate a phone call, that phone call is received by access device 34 in the home or business, preventing access to target telephone 58. Source telephone 32 is connected to target telephone 58 only when the unique access code is provided to access device 34. Since target telephone 58 will only ring when is connected to source telephone 32, target telephone 58 will only ring after the unique access code is provided to access device 34. In this way, a user of target telephone 58 in the home of business where it is located, will only be notified of a call after the unique access code is provided to access device 34 by the phone call initiator.

Although the present invention has been described with reference to preferred embodiments, workers skilled in the art will recognize that changes may be made in form and detail without departing from the spirit and scope of the invention. For example, FIG. 3 describes source and target devices 32 and 58 as telephones. They can also be fax machines, voice mail, computer and other related communication devices. Similarly, although a transmission line connection is described to connect source, access and target devices 32, 34 and 58, a wireless communication coupling is also contemplated consistent with the present invention. Also, although access device 34 is shown as a collection of hardware-type devices, the present invention also contemplates that access device 34 is a microprocessor with associated memory and program that replaces the collection of hardware-type devices to accomplish the same functions that may be a service provided by the telephone service system provider.

1. A method for processing an incoming call from an initiator of the incoming call in a communication system, the method comprising:
intercepting the incoming call preventing communication with a target device for which the incoming call was intended;
prompting the initiator of the incoming call to input a unique access code;
passing the incoming call to the target device upon receiving the unique access code from the initiator of the incoming call; and
prohibiting the incoming call from reaching the target device when the unique access code is not provided by the initiator of the incoming call.

2. The method of claim 1 wherein prompting the initiator of the incoming call to input a unique access code is done without directing the initiator as to what the unique access code is.

3. The method of claim 1 wherein the initiator must have independent knowledge of the unique access code in order to connect to the target device.

4. The method of claim 1 further including:
generating a unique access code;
monitoring an incoming call for signals in response to prompting the initiator of the incoming call; and
comparing the unique access code with the signals from the incoming call.

5. The method of claim 4 wherein the incoming call is passed to the target device when the result of the comparison is that the unique access code is the same as the signals from the incoming call.

6. The method of claim 4 wherein the incoming call is terminated when the result of the comparison between the unique access code and the signals from the incoming call indicate they are not the same.

7. The method of claim 1 wherein prompting the initiator of the incoming call is done by generating a tone signal.

8. The method of claim 1 wherein prompting the initiator of the incoming call is done by a voice message.

9. The method of claim 1 wherein prompting the initiator of the incoming call is done silently such that the initiator of the incoming call does not know it is being prompted to input a unique access code.

10. The method of claim 1 further including terminating the incoming call if a predetermined amount of time passes before the initiator of the incoming call inputs a signal after the initiator has been prompted to input a unique access code.

11. A method for preventing ringing a target device in a communication system, the method comprising:
intercepting an incoming call from an initiator of the incoming call that is intended for the target device;
prompting the initiator of the incoming call to input a unique access code; and
preventing the incoming call from reaching the target device when the unique access code is not provided by the initiator of the incoming call.

12. A communication access code system comprising:
a source communication device;
a target communication device; and
a means for receiving communication from the source communication device, prompting the source communication device for input signals, comparing the input signals received from the source communication device with a stored unique access code, and for coupling the source communication device with the target communication device only when the input signals received from the source device match the stored unique access code.

13. A communication access code system comprising:
a source communication device coupled to an interface, the interface coupled to receive communication signals from the source communication device and to prompt the source communication device for input signals;
a code comparator coupled to a code generator and the interface, the code comparator configured to compare a unique access code from the code generator with the input signals from the source communication device; and
a target communication device configured to be coupled to the source communication device only when the code comparator determines that the unique access code matches the input signals.

14. The apparatus of claim 13 wherein the source communication device is coupled to a call terminator when the code comparator determines that the unique access code from the code generator does not match the input signals from the source communication device.

15. The apparatus of claim 13 wherein the source device is coupled to a message system when the code comparator determines that the unique access code from the code generator does not match the input signals from the source communication device.

16. The apparatus of claim 13 further including a switch coupled to the source communication device, the target communication device, a call terminator, and a message system, the switch controlled by the code comparator such that the switch couples the source communication device and the target communication device when the code comparator indicates a match between the unique access code and the input signals and such that the switch couples the source communication device and the call terminator or the message system when the code comparator indicates the unique access code and the input signals are not a match.
